(19) United States
(12) Patent Application Publication
(10) Pub. No.: US 2018/0088368 A1
(43) Pub. Date: Mar. 29, 2018

(54) LIQUID CRYSTAL DISPLAY DEVICE

(71) Applicant: Panasonic Liquid Crystal Display Co., Ltd., Hyogo (JP)

(72) Inventors: Tomoharu NOTOSHI, Hyogo (JP); Ryosuke YABUKI, Hyogo (JP)

(21) Appl. No.: 15/695,701

(22) Filed: Sep. 5, 2017

(30) Foreign Application Priority Data
Sep. 23, 2016 (JP) 2016-186070

(51) Int. Cl. G02F 1/1335; F21V 8/00; F21V 29/65

(52) U.S. Cl. CPC G02F 1/1336; G02B 6/0085; G02B 6/0068; G02B 6/005; G02B 6/0088; F21V 29/65

(57) ABSTRACT

A liquid crystal display device is provided. The liquid crystal display device includes: a liquid crystal cell, an optical sheet, and a backlight disposed apart from one another; a heat absorber that is disposed in an airtight circulation channel and cools a coolant that circulates in the airtight circulation channel so as to pass through a first channel between the liquid crystal cell and the optical sheet and a second channel between the optical sheet and the backlight; and a heat sink that is thermally coupled to the heat absorber and exposed to ambient air.

### CROSS REFERENCE TO RELATED APPLICATION

The present application is based on and claims priority of Japanese Patent Application No. 2016-186070 filed on Sep. 23, 2016. The entire disclosure of the above-identified application, including the specification, drawings and claims is incorporated herein by reference in its entirety.

### FIELD

The present disclosure relates to a liquid crystal display device.

### BACKGROUND

Liquid crystal display devices are used as, for example, displays in, for example, televisions and monitors due to their capability to display images with low power consumption.

Such a liquid crystal display device includes, for example, a liquid crystal cell, a backlight, and an optical sheet between the liquid crystal cell and the backlight (for example, see Japanese Unexamined Patent Application Publication No. 2007-121339).

### SUMMARY

Among conventional liquid crystal display devices, there is a problem that the optical sheet deteriorates due to heat caused by the backlight.

The present disclosure was conceived to overcome such a problem and has an object to provide a liquid crystal display device capable of inhibiting an optical sheet from deteriorating due to heat caused by a backlight.

In order to achieve the above object, in one aspect, a liquid crystal display device according to the present disclosure includes: a liquid crystal cell, an optical sheet, and a backlight disposed apart from one another; a heat absorber that is disposed in an airtight circulation channel and cools a coolant that circulates in the airtight circulation channel so as to pass through a first channel between the liquid crystal cell and the optical sheet and a second channel between the optical sheet and the backlight; and a heat sink that is thermally coupled to the heat absorber and exposed to ambient air.

According to the present disclosure, it is possible to efficiently cool an optical sheet and thus inhibit the optical sheet from deteriorating due to heat caused by a backlight.

### BRIEF DESCRIPTION OF DRAWINGS

These and other objects, advantages and features of the invention will become apparent from the following description thereof taken in conjunction with the accompanying drawings that illustrate a specific embodiment of the present invention.

FIG. 1 is a plan view schematically illustrating a liquid crystal display device according to an embodiment.

FIG. 2 is a perspective view of the liquid crystal display device according to the embodiment from behind.

FIG. 3 is a cross sectional perspective view of the liquid crystal display device according to the embodiment.

FIG. 4 is a cross sectional perspective view of the top portion of the liquid crystal display device according to the embodiment.

FIG. 5 is a cross sectional perspective view of the bottom portion of the liquid crystal display device according to the embodiment.

FIG. 6 is a cross sectional perspective view of the liquid crystal display device according to the embodiment with the frame removed.

FIG. 7 is a perspective view of part of the liquid crystal display device according to the embodiment with the frame removed, from above.

FIG. 8 is a schematic cross sectional view for illustrating the flow of gas (coolant and ambient air) in and out of the liquid crystal display device according to the embodiment.

### DESCRIPTION OF EMBODIMENT

The following describes an exemplary embodiment of the present disclosure. The embodiment described below is merely one specific example of the present disclosure. The numerical values, shapes, materials, elements, and arrangement and connection of the elements, etc. indicated in the following embodiment are given merely by way of illustration and are not intended to limit the present disclosure. Therefore, among elements in the following embodiment, those not recited in any one of the independent claims defining the broadest inventive concept of the present disclosure are described as optional elements.

Note that the figures are schematic illustrations and are not necessarily precise depictions. Accordingly, the figures are not necessarily to scale. Moreover, in the figures, elements that are essentially the same share like reference signs. Accordingly, duplicate description is omitted or simplified.

In the present description and figures, the X, Y and Z axes represent the three axes in a three-dimensional orthogonal coordinate system. The X and Y axes intersect at a right angle, and the X and Y axes each intersect the Z axis at right angles. In the following embodiment, the positive direction along the Z axis corresponds to the direction in which the front surface of the liquid crystal display device 1 faces.

### Embodiment

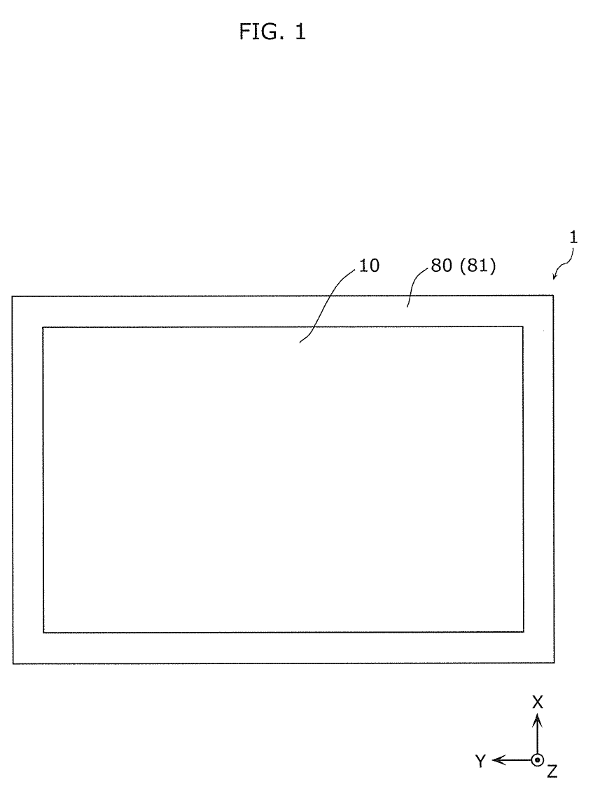

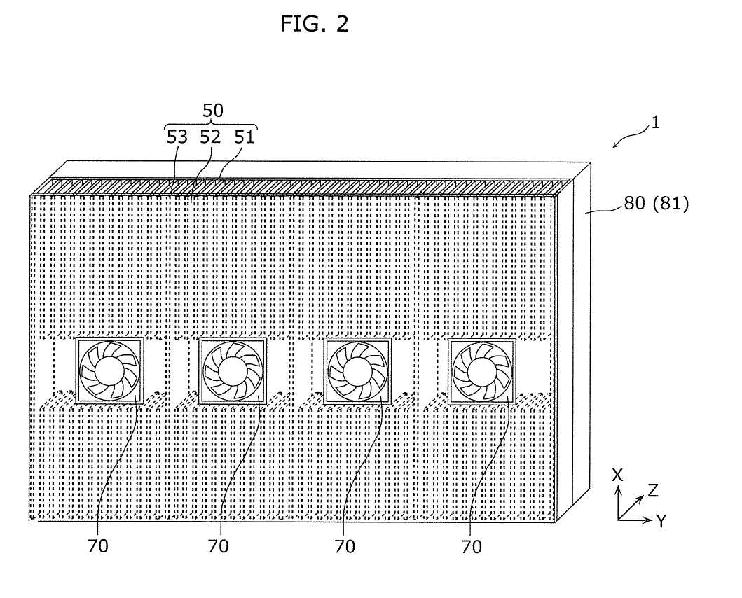

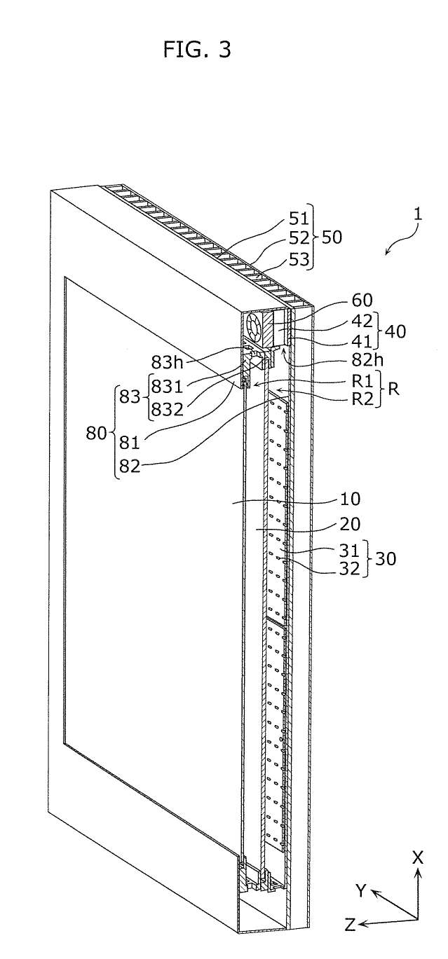

The configuration of the liquid crystal display device 1 according to the embodiment will be described with reference to FIG. 1 through FIG. 3. FIG. 1 is a plan view schematically illustrating the liquid crystal display device 1 according to the embodiment. FIG. 2 is a perspective view of the liquid crystal display device 1 according to the embodiment from behind. FIG. 3 is a cross sectional perspective view of the liquid crystal display device 1 according to the embodiment.

As illustrated in FIG. 1 through FIG. 3, the liquid crystal display device 1 includes a liquid crystal cell 10, an optical sheet 20, and a backlight 30. The liquid crystal cell 10, the optical sheet 20, and the backlight 30 are disposed apart from one another in the listed order. As illustrated in FIG. 3, this configuration allows for an airtight circulation channel R including a first channel R1 between the liquid crystal cell 10 and the optical sheet 20 and a second channel R2 between the optical sheet 20 and the backlight 30 to be formed in the liquid crystal display device 1. A coolant flows in the airtight circulation channel R structured as described above. The coolant (refrigerant) that flows in the airtight circulation channel R is, for example, air such as dry air, but may be, for example: an alternative for chlorofluorocarbons; nitrogen; ammonia; propane; or ethylene.

The liquid crystal display device 1 further includes a heat absorber 40, a heat sink 50, first fans 60, second fans 70, and a frame 80.

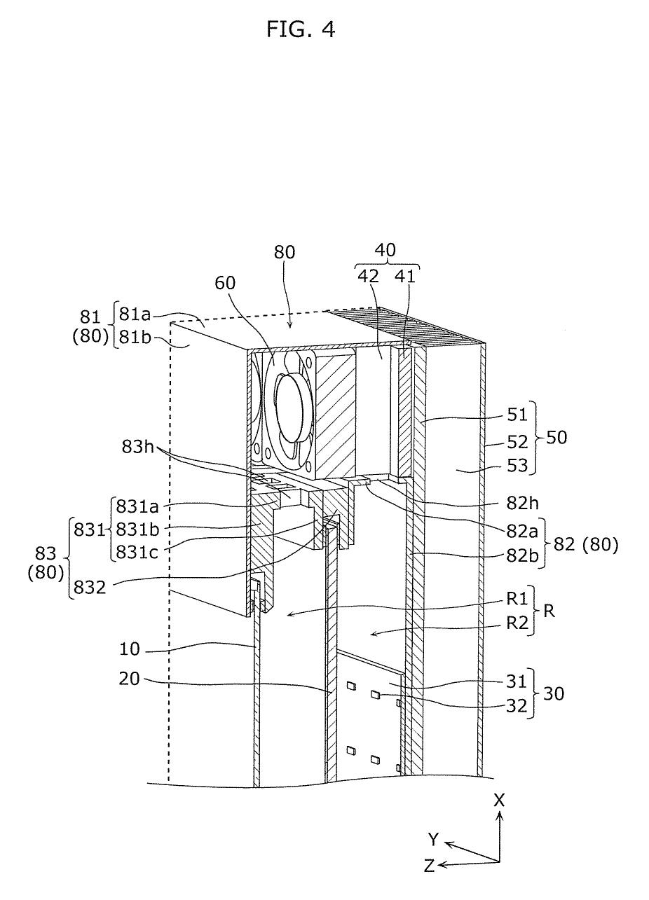

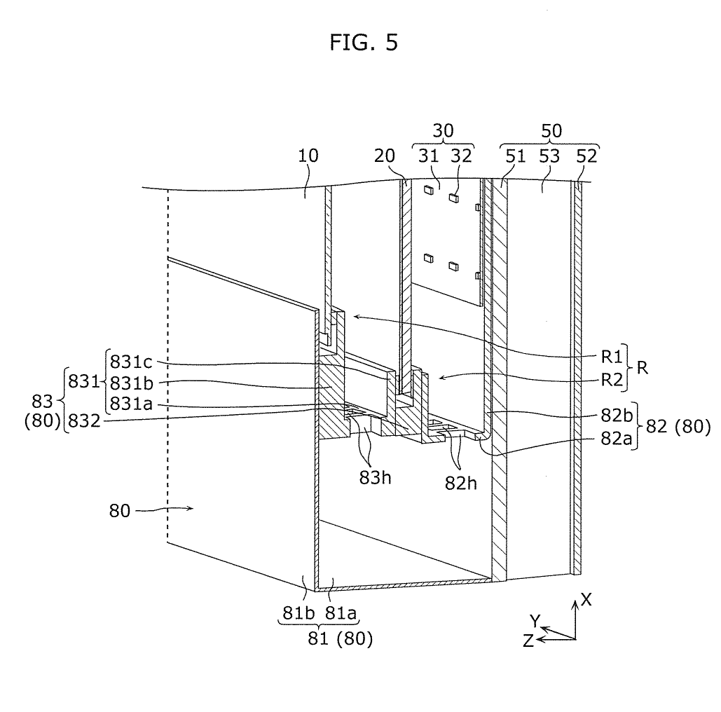

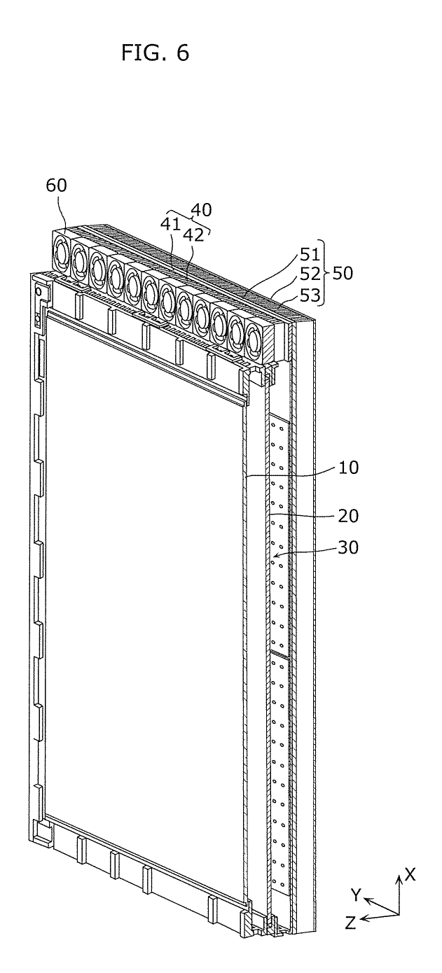

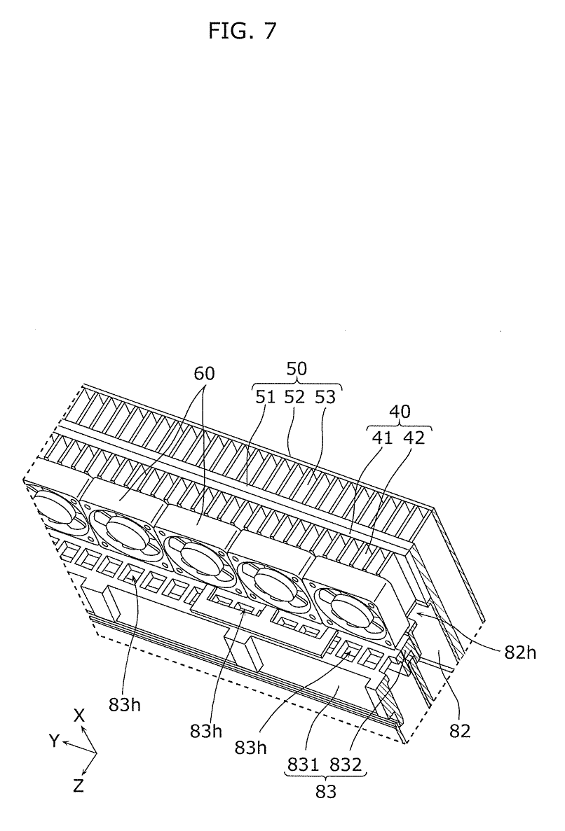

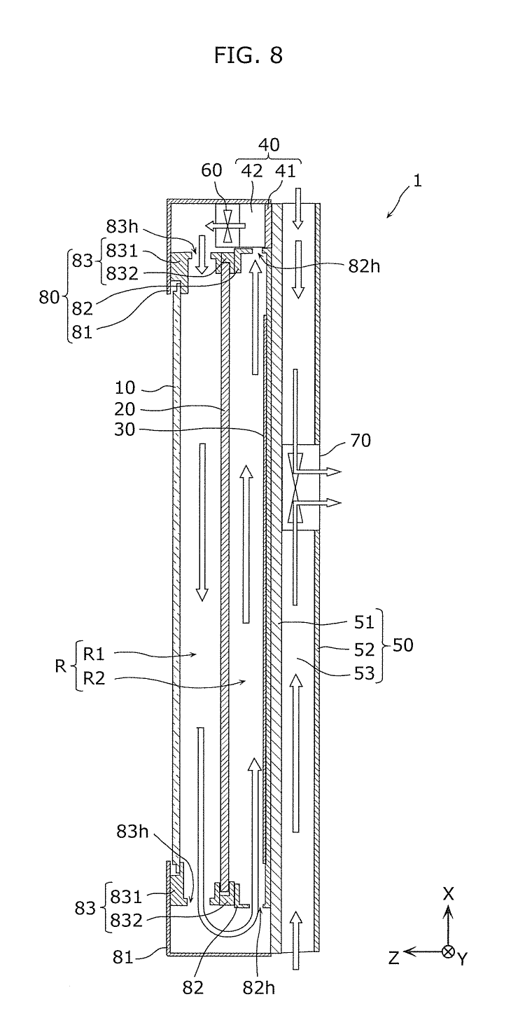

Hereinafter, each element included in the liquid crystal display device 1 according to this embodiment will be described in detail with reference to FIG. 4 through FIG. 8, while also referring back to FIG. 1 through FIG. 3. FIG. 4 is a cross sectional perspective view of the top portion of the liquid crystal display device 1 according to the embodiment. FIG. 5 is a cross sectional perspective view of the bottom portion of the liquid crystal display device 1 according to the embodiment. FIG. 6 is a cross sectional perspective view of the liquid crystal display device 1 with the frame 80 removed. FIG. 7 is a perspective view of part of the liquid crystal display device 1 illustrated in FIG. 6, from above. FIG. 8 is a schematic cross sectional view for illustrating the internal and external flow of gas (coolant and ambient air) relative to the liquid crystal display device 1 according to the embodiment.

The liquid crystal cell 10 illustrated in FIG. 1 and FIG. 3 is a liquid crystal panel that displays an image on the display surface, which is the front surface. More specifically, the liquid crystal cell 10 is open cell (OC) in which a liquid crystal layer is sealed between a pair of opposing transparent substrates.

The transparent substrate that is closer to the backlight 30 among the pair of transparent substrates is a thin film transistor (TFT) substrate including TFTs corresponding one-to-one with the pixels arranged in a matrix. The other transparent substrate that is closer to the display surface among the pair of transparent substrates is a color filter (CF) substrate including a CF. For example, glass and/or transparent resin substrates may be used as the pair of transparent substrates. The liquid crystal material used for the liquid crystal layer may be selected according to the method used to drive the liquid crystal cell 10.

Moreover, polarizers (polarizing films) are bonded to the outer surfaces of the pair of transparent substrates. The pair of polarizers are disposed such that their respective polarizing directions are orthogonal to one another. Moreover, a phase retarder (phase retarding film) may be bonded to each polarizer.

In this embodiment, the liquid crystal cell 10 is, but not limited to, being driven using an in-plane switching (IPS) driving method; a vertical alignment (VA) or twisted nematic (TN) driving method may be used. A driver substrate on which a driver integrated circuit (IC) is formed is connected to the liquid crystal cell 10 via a flexible substrate such as a flexible printed circuit (FPC).

As illustrated in FIG. 3, the optical sheet 20 is disposed between the liquid crystal cell 10 and the backlight 30. The optical sheet 20 is disposed a predetermined distance apart from the liquid crystal cell 10 and a predetermined distance apart from the backlight 30.

In this embodiment, the optical sheet 20 is a quantum dot film including quantum dots that convert the wavelength of the light emitted by the backlight 30. For example, a quantum dot enhancement film (QDEF) may be used as the quantum dot film.

More specifically, when blue LED elements that emit blue light are used as the LEDs 32 in the backlight 30, a quantum dot film that converts incident light into light having peak wavelengths in the green and red wavelength ranges may be used. In this case, as one example, a quantum dot film may be used that contains two types of quantum dots, one that converts the blue light from the LEDs 32 into green light, and one that converts the blue light from the LEDs 32 into red light. This configuration results in white light being emitted from the quantum dot film due to green light and red light, produced by wavelength conversion by the quantum dot film absorbing blue light from the LEDs 32, mixing with unabsorbed blue light from the LEDs 32 to produce white light. Note that two types of quantum dots having different diameters may be used to convert the blue light into green light and red light.

Moreover, in addition to the quantum dot film, the optical sheet 20 may also include, for example, a diffuser sheet that diffuses (scatters) the white light emitted from the quantum dot film. This results in emission of light from the optical sheet 20 toward the liquid crystal cell 10 that is evenly scattered (diffused) across a plane.

As illustrated in FIG. 3, the backlight 30 is disposed behind the optical sheet 20, and emits light toward the optical sheet 20. The backlight 30 is disposed a predetermined distance apart from the optical sheet 20. The backlight 30 is disposed in front of a first heat-dissipating plate 51 included in the heat sink 50. More specifically, the backlight 30 is mounted on a rear frame 82 disposed on the first heat-dissipating plate 51.

The backlight 30 includes substrates 31 and LEDs 32. In this embodiment, the backlight 30 is a direct-lit LED backlight controllable so as to enable local dimming.

Each substrate 31 is a light source substrate on which the LEDs 32 are disposed. For example, resin-based substrates (for example, CEM-3), metal-based substrates, or a ceramic substrates made of ceramic may be used as the substrates 31. Each substrate 31 may be a rigid substrate and may be a flexible substrate.

The substrates 31 are mounted on the rear frame 82 on the first heat-dissipating plate 51 of the heat sink 50. In this embodiment, the backlight 30 includes a plurality of substrates 31 mounted on the rear frame 82, but the backlight 30 may include a single substrate 31. For example, the substrates 31 are fixed to the rear frame 82.

The LEDs 32 are arranged in a two-dimensional array at a predetermined pitch on the front surface (the surface facing the liquid crystal cell 10) of each substrate 31. More specifically, the LEDs 32 are arranged in a matrix corresponding to the horizontal (Y axis) pixel rows and vertical (X axis) pixel columns.

The LEDs 32 are one example of the light-emitting elements used as the light source for the backlight 30. In this embodiment, the LEDs 32 are packaged surface mount device (SMD) LED elements. In one example, the LEDs 32 each include a white resin package (container) including a cavity, an LED chip (bare chip) one-dimensionally mounted on the bottom surface of the package cavity, and a sealant that encapsulates the LED chip in the package cavity.

The LED chip is one example of a semiconductor light-emitting element that emits light in response to predetermined DC power, and is a bare chip that emits monochromatic visible light. In this embodiment, since the optical sheet 20 includes a quantum dot film containing quantum dots that are excited by and convert the wavelength of blue light, blue LED elements that emit blue light are used as the LEDs 32 so as to function as an excitation light source for the quantum dots. Accordingly, a blue LED chip that emits blue light when current passes through is used as the LED chip. For example, a gallium nitride semiconductor light-emitting element made of, for example, InGaN, and having a central wavelength in a range of from 440 nm to 470 nm, inclusive, may be used as the blue LED chip.

As illustrated in FIG. 3 and FIG. 4, the heat absorber 40 is disposed in the airtight circulation channel R in which the coolant circulates so as to pass through the first channel R1, which is between the liquid crystal cell 10 and the optical sheet 20, and the second channel R2, which is between the optical sheet 20 and the backlight 30.

As illustrated in FIG. 8, the coolant in the liquid crystal display device 1 is sealed in the airtight circulation channel R and flows so as to circulate in the airtight circulation channel R. The heat absorber 40 absorbs heat from the coolant flowing in the airtight circulation channel R. In other words, the heat absorber 40 functions as a heat sink that pulls heat from the coolant flowing in the airtight circulation channel R.

In this embodiment, the heat absorber 40 is a body made of a metal having a high thermal conductivity, such as aluminum or copper. More preferably, the heat absorber 40 is made of copper, which has a higher thermal conductivity than aluminum. In this embodiment, the heat absorber 40 is made of a metal having a higher thermal conductivity than that of the material or materials from which the front frame 81, rear frame 82, and intermediate frame 83 are formed.

The heat absorber 40 is disposed in front of the first heat-dissipating plate 51 of the heat sink 50. More specifically, the heat absorber 40 is disposed on the first heat-dissipating plate 51 so as to be in contact with the first heat-dissipating plate 51. This makes it possible to efficiently conduct heat from the heat absorber 40 to the heat sink 50.

Moreover, when the liquid crystal display device 1 stands vertically such that the front surface of the liquid crystal cell 10 is facing horizontally (when the liquid crystal display device 1 stands such that the liquid crystal cell 10, the optical sheet 20, and the backlight 30 stand vertically), the heat absorber 40 is disposed in the uppermost portion of the airtight circulation channel R. In other words, the heat absorber 40 is disposed in the region of the boundary between the first channel R1 and the second channel R2. This configuration makes it possible to efficiently pull, via the heat absorber 40, heat, which tends to pool in the uppermost part of the airtight circulation channel R when the liquid crystal display device 1 is stands vertically.

In this embodiment, the heat absorber 40 includes a first heat-absorbing plate 41 that is elongated along the Y axis and a plurality of second heat-absorbing plates 42 disposed on the first heat-absorbing plate 41. The first heat-absorbing plate 41 and the second heat-absorbing plates 42 are, for example, metal plates.

The first heat-absorbing plate 41 is disposed on the first heat-dissipating plate 51 of the heat sink 50, in a location corresponding to the uppermost part of the airtight circulation channel R when the liquid crystal display device 1 stands vertically. More specifically, the first heat-absorbing plate 41 is mounted on an end portion of the first heat-dissipating plate 51.

The second heat-absorbing plates 42 are arranged standing on the first heat-absorbing plate 41, spaced a predetermined distance from each other in the lengthwise direction of the first heat-absorbing plate 41 (corresponding to the Y axis in this embodiment). In other words, each second heat-absorbing plate 42 is disposed on the first heat-absorbing plate 41 such that the second heat-absorbing plate 42 and the first heat-absorbing plate 41 have a T-shaped cross section. Note that the second heat-absorbing plates 42 are spaced apart at, for example, a uniform distance.

Two adjacent second heat-absorbing plates 42 among the plurality of second heat-absorbing plates 42 partially define therebetween the airtight circulation channel R. In other words, coolant passes through the space between two adjacent second heat-absorbing plates 42. In this embodiment, the space between two adjacent second heat-absorbing plates 42 is formed in plurality per second heat-absorbing plate 42.

Note that the heat absorber 40, the first heat-absorbing plate 41, and the second heat-absorbing plates 42 may be fixed together by, for example, welding the second heat-absorbing plates 42 to the first heat-absorbing plate 41, and the first heat-absorbing plate 41 and the second heat-absorbing plates 42 may be formed as a single integral unit.

The heat sink 50 is thermally coupled to the heat absorber 40 and exposed to ambient air. This makes it possible to efficiently conduct heat from the heat absorber 40 to the heat sink 50 and dissipate the heat to the ambient air.

As illustrated in FIG. 3 and FIG. 4, the heat sink 50 is disposed behind the rear frame 82. The heat sink 50 includes a first heat-dissipating plate 51, a second heat-dissipating plate 52, and heat-dissipating fins 53. The first heat-dissipating plate 51, the second heat-dissipating plate 52, and the heat-dissipating fins 53 are plates made of metal having a high thermal conductivity, such as aluminum or copper.

The backlight 30 and the heat absorber 40 are disposed in front of (on the liquid crystal cell 10 side of) the first heat-dissipating plate 51. The second heat-dissipating plate 52 is disposed parallel to the first heat-dissipating plate 51, at a predetermined distance from the first heat-dissipating plate 51.

The first heat-dissipating plate 51 and the second heat-dissipating plate 52 are, for example, rectangular metal plates in a plan view, and are disposed so as to cover the rear frame 82 of the frame 80 in entirety. The first heat-dissipating plate 51 and the second heat-dissipating plate 52 are, but not limited to, metal plates having the same outline.

In this embodiment, the first heat-dissipating plate 51 is a metal plate that is larger than the rear frame 82 in a plan view. Moreover, the first heat-dissipating plate 51 is disposed so as to be in contact with the rear surface of the rear frame 82. Disposing the first heat-dissipating plate 51 in this manner makes airtight circulation channel R an airtight space. In this embodiment, the airtight circulation channel R is configured such that the optical sheet 20 is disposed in a space sealed by the first heat-dissipating plate 51, the front frame 81 of the frame 80, and the liquid crystal cell 10.

As illustrated in FIG. 2 and FIG. 3, the heat-dissipating fins 53 are disposed behind the backlight 30, outside the airtight circulation channel R. Each heat-dissipating fin 53 stands on the rear surface of the first heat-dissipating plate 51. More specifically, the heat-dissipating fins 53 are sandwiched between the first heat-dissipating plate 51 and the second heat-dissipating plate 52, and stand apart from one another at a predetermined distance along the Y axis.

With this configuration, the heat sink 50 is provided with a plurality of rectangular tubular spaces each surrounded by two adjacent heat-dissipating fins 53, the first heat-dissipating plate 51, and the second heat-dissipating plate 52. These spaces function as channels in which ambient air introduced into the heat sink 50 flows. Accordingly, covering the open surface of the heat-dissipating fins 53 with the second heat-dissipating plate 52 forms a space (channel) surrounded on four sides by the top, bottom, left, and right walls in a cross section. This makes it possible to efficiently rectify airflow by causing the ambient air introduced into the heat sink 50 to flow through the spaces. In other words, the second heat-dissipating plate 52 functions as a rectifier that rectifies the airflow of ambient air.

Note that, as illustrated in FIG. 2, in order to dispose the second fans 70 in the heat sink 50, the space between the first heat-dissipating plate 51 and the second heat-dissipating plate 52 includes a region void of heat-dissipating fins 53.

As illustrated in FIG. 3 and FIG. 4, the first fans 60 are disposed in the airtight circulation channel R. Accordingly, driving the first fans 60 makes it possible to efficiently circulate the coolant in the airtight circulation channel R. In other words, the first fans 60 are circulation fans, and can forcibly generate convective flow in the airtight circulation channel R. With this, as illustrated in FIG. 8, the cooling path can be made to loop in a single direction in the airtight circulation channel R.

The first fans 60 are disposed proximate to the heat absorber 40. In this embodiment, since the heat absorber 40 is disposed in the uppermost portion of the airtight circulation channel R, the first fans 60 are also disposed in the uppermost portion of the airtight circulation channel R. In other words, similar to the heat absorber 40, the first fans 60 are also disposed in the region of the boundary between the first channel R1 and the second channel R2.

As illustrated in FIG. 6 and FIG. 7, the first fans 60 are aligned along the Y axis. More specifically, the first fans 60 are aligned continuously with no gap therebetween so as to cover all openings formed by the second heat-absorbing plates 42.

Note that the first fans 60 may be, but are not limited to, for example, axial fans; the first fans 60 may be, for example, centrifugal fans.

As illustrated in FIG. 2, the second fans 70 are for introducing ambient air into spaces between the heat-dissipating fins 53 of the heat sink 50. The second fans 70 are disposed behind the backlight 30, outside the airtight circulation channel R. Driving the second fans 70 makes it possible to pull ambient air into the heat sink 50 from outside the heat sink 50.

More specifically, as illustrated in FIG. 8, by driving the second fans 70, ambient air is drawn in from the openings at both ends of each space (channel) surrounded by two adjacent heat-dissipating fins 53, the first heat-dissipating plate 51, and the second heat-dissipating plate 52, flows in the spaces, and is expelled through the second fans 70 disposed in a region of the spaces. This makes it possible to efficiently dissipate, to the ambient air, heat conducted to the heat sink 50, to expel the heat out of the heat sink 50.

Note that the flow of ambient air illustrated in FIG. 8 may be reversed: the ambient air may be drawn into the heat sink 50 through second fans 70 and be expelled from the openings at both ends of each space surrounded by two adjacent heat-dissipating fins 53, the first heat-dissipating plate 51, and the second heat-dissipating plate 52.

As illustrated in FIG. 2, the second fans 70 can be disposed in a region void of heat-dissipating fins 53 in the heat sink 50. In this embodiment, the second fans 70 comprise, but are not limited to, four fans.

Note that the second fans 70 may be, but are not limited to, for example, axial fans; the second fans 70 may be, for example, centrifugal fans.

As illustrated in FIG. 3, the frame 80 includes a front frame 81, a rear frame 82, and an intermediate frame 83 (middle frame).

As illustrated in FIG. 1, the front frame 81 has a rectangular frame-like shape in a plan view, and as illustrated in FIG. 3, has an L-shaped cross section. The front frame 81 includes: a side wall 81a disposed on a lateral side of the liquid crystal cell 10, the optical sheet 20, and the backlight 30; and a bezel 81b that covers the outer periphery of the liquid crystal cell 10. The front frame 81 is an outer component that forms the outer contour of the frame 80, and may be made of a rigid material, such as a copper plate.

The rear frame 82 includes: a side wall 82a disposed on a lateral side of the liquid crystal cell 10, the optical sheet 20, and the backlight 30; and a rear surface section 82b that covers the rear surface of backlight 30. Like the front frame 81, the rear frame 82 may be made of a rigid material, such as a copper plate.

As illustrated in FIG. 4 and FIG. 5, the side walls 82a of the rear frame 82 are disposed at the X axis ends of rear surface section 82b. In this embodiment, a plurality of through holes 82h are formed in each side wall 82a. More specifically, the through holes 82h are formed in a single line along the Y axis.

The through holes 82h in the rear frame 82 are disposed in the airtight circulation channel R, and function as communicative holes for communicatively connecting the first channel R1 and the second channel R2. In other words, the coolant flowing in the airtight circulation channel R passes through the through holes 82h. More specifically, the through holes 82h communicatively connect the second channel R2 with spaces formed between the second heat-absorbing plates 42 in the heat absorber 40.

The intermediate frame 83 is a holding component for holding the liquid crystal cell 10 and the optical sheet 20, and is disposed between the front frame 81 and the rear frame 82. A molded frame formed by molding composite resin may be used as the intermediate frame 83, but the material of the intermediate frame 83 is not limited to a resin material; the intermediate frame 83 may be made of a metal material.

In this embodiment, the intermediate frame 83 includes a first intermediate component 831 and a second intermediate component 832. The first intermediate component 831 and the second intermediate component 832 are separate components that are separable, but may be molded as a single integral unit.

The first intermediate component 831 is disposed between the liquid crystal cell 10 and the optical sheet 20. The first intermediate component 831 has a U-shaped cross section and an approximately rectangular frame-like plan view shape. The first intermediate component 831 includes a side wall 831a that faces the side wall 81a of the front frame 81, and first protrusions 831b and second protrusions 831c that protrude from the side wall 831a. The second intermediate component. 832 is a frame component having an approximately rectangular plan view shape, and has a stepped structure at its inner peripheral edge.

The liquid crystal cell 10 is held by the intermediate frame 83 as a result of the end portions of the liquid crystal cell 10 being held between the bezel 81b of the front frame 81 and a stepped structure of the first protrusions 831b of the first intermediate component 831. The optical sheet 20 is held by the intermediate frame 83 as a result of the end portions of the optical sheet 20 being held between the second protrusions 831c of the first intermediate component 831 and the stepped structure of the second intermediate component 832.

The intermediate frame 83 defines through holes 83h. More specifically, the through holes 83h are formed in the side walls 831a of the first intermediate component 831. In this embodiment, the through holes 83h are formed in a single line along the Y axis.

The through holes 83h in the intermediate frame 83 are disposed in the airtight circulation channel R, and function as communicative holes for communicatively connecting the first channel R1 and the second channel R2. In other words, the coolant flowing in the airtight circulation channel R passes through the through holes 83h. More specifically, the through holes 83h communicatively connect the first channel R1 with spaces formed between the second heat-absorbing plates 42 in the heat absorber 40.

The liquid crystal display device 1 configured in this manner is HDR-compatible, which is compatible with, for example, 4K/8K, and as described above, a high-luminosity direct-lit LED backlight capable of local dimming is used as the backlight 30. This makes it possible to display a high contrast, high-quality color image.

Next, the advantageous effects of the liquid crystal display device 1 according to this embodiment as well as how the techniques of the present disclosure were arrived at will be described.

Among conventional liquid crystal display devices, there is a problem that the optical sheet deteriorates due to heat caused by the backlight.

More specifically, one conceivable cause is that heat generated by the backlight's light source (for example, LEDs) propagates to the optical sheet whereby the optical sheet deteriorates. Another conceivable cause is that light from the backlight is absorbed by the liquid crystal cell as it passes through the liquid crystal cell and is converted into heat, whereby the heat generated in the liquid crystal cell propagates to the optical sheet and causes the optical sheet to deteriorate.

As a result of research on the part of the inventors, they discovered that once heat accumulates in the optical sheet, it is more difficult to cool than the liquid crystal cell or the backlight is. This is due to the optical sheet being internally enclosed rather than exposed to ambient air, which makes it relatively difficult to dissipate heat from the optical sheet and relatively easy for heat to accumulate in the optical sheet, as opposed to the liquid crystal cell and the backlight from which heat is relatively easily dissipated due to the front surface of the liquid crystal cell being exposed to ambient air and the heat sink being disposed behind the backlight.

Here, the heat in the optical sheet is caused by the light from the backlight. More specifically, a portion of the light from the backlight is absorbed by the optical sheet as it passes through the optical sheet, and the light from the backlight that is absorbed by the optical sheet is converted into heat and thus the optical sheet generates heat. The optical sheet deteriorates due to the heat it generates.

In this way, among conventional liquid crystal display devices, there is a problem that the optical sheet deteriorates due to not only heat conducted from the backlight, but from heat generating in the optical sheet from light from the backlight.

In particular, when a direct-lit backlight with HDR local dimming capabilities is used, the light from the backlight is high in luminosity, and is repeatedly and locally emitted on the optical sheet, which considerably deteriorates the optical sheet.

In contrast, as illustrated in FIG. 8, the liquid crystal display device 1 according to this embodiment includes: a liquid crystal cell 10, an optical sheet 20, and a backlight 30 disposed apart from one another; a heat absorber 40 that is disposed in an airtight circulation channel R and absorbs heat from a coolant that circulates in the airtight circulation channel R so as to pass through a first channel R1 between the liquid crystal cell 10 and the optical sheet 20 and a second channel R2 between the optical sheet 20 and the backlight 30; and a heat sink 50 that is thermally coupled to the heat absorber 40 and exposed to ambient air.

With this configuration, coolant circulates in an airtight circulation channel R including a first channel R1 between the liquid crystal cell 10 and the optical sheet 20 and a second channel R2 between the optical sheet 20 and the backlight 30. Accordingly, the liquid crystal cell 10, the optical sheet 20, and the backlight 30 can be efficiently cooled by the circulating coolant. In other words, heat from the liquid crystal cell 10, the optical sheet 20, and the backlight 30 can be conducted to the coolant and efficiently dissipated.

Moreover, the heat absorber 40 that absorbs heat from the coolant is disposed in the airtight circulation channel R and is in thermal contact with the heat sink 50 that is exposed to ambient air. With this, heat conducted to the coolant is absorbed by the heat absorber 40 and efficiently dissipated to ambient air via the heat sink 50. This makes it possible to continue cooling the liquid crystal cell 10, the optical sheet 20, and the backlight 30 since the cooling function of the coolant is maintained. Accordingly, the temperature of the liquid crystal cell 10, the optical sheet 20, and the backlight 30 can be efficiently inhibited from increasing.

In particular, with the liquid crystal display device 1 according to this embodiment, since both surfaces of the optical sheet 20 are surrounded by the first channel R1 and the second channel R2, the optical sheet 20 can be efficiently cooled even when the optical sheet 20 is internally enclosed and not exposed to ambient air. This makes it possible to efficiently draw heat from the optical sheet 20 to cool the optical sheet 20 and thus inhibit the optical sheet 20 from deteriorating due to heat caused by the backlight 30.

Moreover, with the liquid crystal display device 1 according to this embodiment, since the airtight circulation channel R is an airtight space, infiltration of dust and/or bugs, etc., into the airtight circulation channel R can be inhibited.

Moreover, in the liquid crystal display device 1 according to this embodiment, the optical sheet 20 includes a quantum dot film including quantum dots that convert the wavelength of the light emitted by the backlight 30.

Quantum dot film is vulnerable to heat and light, so when a quantum dot film is used as the optical sheet 20, there is a problem that the life span and reliability of the liquid crystal display device reduces. However, with the liquid crystal display device 1 according to this embodiment, since the optical sheet 20 can be efficiently cooled, even when a quantum dot film is used as the optical sheet 20, the life span and reliability of the liquid crystal display device 1 can be inhibited from reducing. Moreover, by using a quantum dot film as the optical sheet 20, it is possible to achieve a liquid crystal display device having more desirable color rendering properties than when white LED elements are used as the light sources in the backlight 30.

Moreover, the liquid crystal display device 1 according to this embodiment further includes an intermediate frame 83 for holding the optical sheet 20. The intermediate frame 83 includes a first intermediate component 831 defining through holes 83h for communicatively connecting the first channel R1 and the second channel R2 in the airtight circulation channel R.

This makes it possible to form through holes 83h that communicatively connect the first channel R1 and the second channel R2 using the intermediate frame 83 for holding the optical sheet 20, without the need for through holes in the liquid crystal cell 10, the optical sheet 20, and/or the backlight 30.

Moreover, the liquid crystal display device 1 according to this embodiment further includes first fans 60 disposed in the airtight circulation channel R.

With this, convective flow can be forcibly generated in the airtight circulation channel R by the first fans 60 to circulate the coolant in one direction. Accordingly, the optical sheet 20 can be further efficiently cooled and the heat absorbed by the heat absorber 40 can be efficiently conducted to the heat sink 50. As a result, the optical sheet 20 can be even more efficiently cooled.

Moreover, in the liquid crystal display device 1 according to this embodiment, the first fans 60 are disposed proximate to the heat absorber 40.

This makes it possible to not only forcibly circulate the coolant using first fans 60, but cool the heat absorber 40 via the airflow generated by the first fans 60. This in turn improves the cooling ability of the heat absorber 40, which draws heat from the coolant. As a result, heat can be further efficiently dissipated from the optical sheet 20 whereby the optical sheet 20 can be even more efficiently cooled.

Moreover, in the liquid crystal display device 1 according to this embodiment, the heat absorber 40 includes second heat-absorbing plates 42. Two adjacent second heat-absorbing plates 42 among the plurality of second heat-absorbing plates 42 partially define therebetween the airtight circulation channel R.

With this, the coolant can pass through the space between two adjacent second heat-absorbing plates 42 functioning as part of the airtight circulation channel R. By passing the coolant between the second heat-absorbing plates 42, coolant can be ensured to have a large contact surface area with the heat absorber 40. Accordingly, it is possible to efficiently draw heat from the coolant using the heat absorber 40. As a result, the optical sheet 20 can be even more efficiently cooled.

Moreover, in the liquid crystal display device 1 according to this embodiment, the heat sink 50 includes heat-dissipating fins 53 behind the backlight 30.

Inclusion of the heat-dissipating fins 53 makes it possible to increase the overall surface area of the heat sink 50. This makes it possible to efficiently dissipate heat absorbed by the heat absorber 40 to the ambient air via the heat sink 50. As a result, the cooling ability of the heat absorber 40 that draws the heat from the coolant can be maintained at a high level whereby the optical sheet 20 can be even more efficiently cooled.

Moreover, the liquid crystal display device 1 according to this embodiment further includes second fans 70 behind the backlight 30, for introducing ambient air into spaces between the heat-dissipating fins 53.

This makes it possible to efficiently dissipate, to the ambient air, heat conducted to the heat sink 50 from the heat absorber 40, to expel the heat out of the heat sink 50 since ambient air is forcibly introduced into the heat sink 50 by the second fans 70. As a result, the cooling ability of the heat absorber 40 that draws the heat from the coolant can be increased even higher, whereby the optical sheet 20 can be even more efficiently cooled.

Moreover, in the liquid crystal display device 1 according to this embodiment, the heat sink 50 includes a first heat-dissipating plate 51, the heat-dissipating fins 53 stand on a rear surface of the first heat-dissipating plate 51, and the backlight 30 and the heat absorber 40 are disposed in front of the first heat-dissipating plate 51.

With this, since the backlight 30 and the heat absorber 40 are disposed in front of the first heat-dissipating plate 51 on the rear surface of which the heat-dissipating fins 53 stand, heat absorbed by the heat absorber 40 can be efficiently dissipated to the ambient air and heat generated by the backlight 30 can be efficiently dissipated to the ambient air. Accordingly, in addition to the heat from the optical sheet 20 being even more efficiently conducted to the coolant, the heat from the backlight 30 can be inhibited from being conducted to the optical sheet 20. As a result, deterioration of the optical sheet 20 due to heat can be inhibited even further.

Moreover, in the liquid crystal display device 1 according to this embodiment, the heat absorber 40 is disposed in an uppermost portion of the airtight circulation channel R when the liquid crystal display device 1 stands vertically.

When the liquid crystal display device 1 stands vertically and the temperature of the coolant rises, the coolant moves to the uppermost portion of the airtight circulation channel R. Accordingly, by disposing the heat absorber 40 in the uppermost portion of the airtight circulation channel R, heat from the coolant can be efficiently absorbed by the heat absorber 40. As a result, the optical sheet 20 can be even more efficiently cooled.

### Variations

While the liquid crystal display device according to the present disclosure has been described according to an exemplary embodiment, the present disclosure is not limited to this embodiment.

For example, in the above embodiment, the backlight 30 is exemplified as, but not limited to, a direct-lit LED backlight including LEDs 32 arranged in a matrix on the substrates 31; the backlight 30 may be an edge-lit backlight including a light guide plate, a light source disposed at the edge surfaces of the light guide plate, and a reflector disposed on the rear surface of the light guide plate. Moreover, the light source of the backlight 30 is not limited to LEDs 32.

Moreover, in the above embodiment, the heat absorber 40 is, but not limited to being, disposed in an uppermost portion of the airtight circulation channel R when the liquid crystal display device 1 stands vertically. For example, when the liquid crystal display device 1 stands vertically, an additional heat absorber 40 may be disposed in the lowermost portion of the airtight circulation channel R, and the heat absorber 40 may be disposed in only the lowermost portion of the airtight circulation channel R.

Moreover, in the above embodiment, the heat sink 50 need not include the second heat-dissipating plate 52. This configuration still allows for the entirety of the heat-dissipating fins 53 to be directly exposed to the ambient air, and accordingly, in configurations where the second fans 70 are to be omitted, dissipation efficiency from the heat-dissipating fins 53 to the ambient air can be improved.

Moreover, in the above embodiment, the first fans 60 are disposed in the airtight circulation channel R, but the first fans 60 may be omitted. In such cases, the coolant circulates in the airtight circulation channel R by natural convection.

Those skilled in the art will readily appreciate that many modifications are possible in the above exemplary embodiment and variations without materially departing from the novel teachings and advantages of the present disclosure. Accordingly, all such modifications are intended to be included within the scope of the present disclosure.

1. A liquid crystal display device comprising:
a liquid crystal cell, an optical sheet, and a backlight disposed apart from one another;
a heat absorber that is disposed in an airtight circulation channel and cools a coolant that circulates in the airtight circulation channel so as to pass through a first channel between the liquid crystal cell and the optical sheet and a second channel between the optical sheet and the backlight; and
a heat sink that is thermally coupled to the heat absorber and exposed to ambient air.

2. The liquid crystal display device according to claim 1, wherein
the optical sheet includes a quantum dot film including quantum dots that convert a wavelength of light emitted by the backlight.

3. The liquid crystal display device according to claim 1, further comprising:
an intermediate frame for holding the optical sheet,
wherein the intermediate frame includes an intermediate component provided with a through hole for communicatively connecting the first channel and the second channel.

4. The liquid crystal display device according to claim 1, further comprising:
a fan disposed in the airtight circulation channel.

5. The liquid crystal display device according to claim 4, wherein
the fan is proximate to the heat absorber.

6. The liquid crystal display device according to claim 1, wherein
the heat absorber includes heat-absorbing plates, and
two adjacent heat-absorbing plates among the heat-absorbing plates partially define therebetween the airtight circulation channel.

7. The liquid crystal display device according to claim 1, wherein
the heat sink includes heat-dissipating fins outside the airtight circulation channel, behind the backlight.

8. The liquid crystal display device according to claim 7, further comprising:
a fan outside the airtight circulation channel, behind the backlight, for introducing ambient air into spaces between the heat-dissipating fins.

9. The liquid crystal display device according to claim 7, wherein
the heat sink includes a heat-dissipating plate,
the heat-dissipating fins stand on a rear surface of the heat-dissipating plate, and
the backlight and the heat absorber are disposed in front of the heat-dissipating plate.

10. The liquid crystal display device according to claim 1, wherein
the heat absorber is disposed in an uppermost portion of the airtight circulation channel when the liquid crystal display device stands vertically.
